(19) United States
(12) Patent Application Publication
(10) Pub. No.: US 2010/0194601 A1
(43) Pub. Date: Aug. 5, 2010

(54) Device for Presenting and Selecting Data on a Display Screen

(75) Inventors: Xavier Servantie, Pessac (FR); Denis Bonnet, Bordeaux (FR); Nicolas Dides, Merignac (FR); Roland Tomczak, Toulouse (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: THALES, Neuilly Sur Seine (FR)

(21) Appl. No.: 12/678,983

(22) PCT Filed: Sep. 16, 2008
(86) PCT No.: PCT/EP2008/062294

§ 371 Date: Mar. 18, 2010

(30) Foreign Application Priority Data
Sep. 18, 2007 (FR) 0706556

(51) Int. Cl. G01C 21/20

(52) U.S. Cl. 340/971

(57) ABSTRACT

The general field of the invention is that of display devices for the management of systems comprising at least means of generating and displaying information concerning the system and a designator. The devices according to the invention are such that:

the information is classified by information themes, each information item is represented by one or more information symbols, a display priority level is associated with each information symbol of a given theme arranged so that, when the information symbols of a given priority level are displayed, all the symbols of higher priority level are displayed, all the symbols of lower priority level are not displayed;

the display means comprise sets of information control symbols, the display of the control symbols being controlled by the designator, each set of control symbols being associated with a given information theme, the displayed control symbols corresponding to the display priority levels of the information symbols of said theme, the display of the control symbols controlling the display of the information symbols of the associated display priority levels.

### PRIORITY CLAIM

This application claims priority to PCT Patent Application Number PCT/EP2008/062294 entitled Device for Presenting and Selecting Data on a Display Screen, filed on Sep. 16, 2008.

### FIELD OF THE INVENTION

The technical field of the invention is that of the presentation of data on display screens. The invention applies more particularly to the aeronautical field.

### BACKGROUND OF THE INVENTION

In a certain number of industrial applications, it is necessary to present to a user a great wealth of information in order to manage, monitor or control a complex system. In the aeronautical field, notably, the ongoing advances made in the onboard electronics and the associated systems make it possible to present to the crew a very large quantity of information regarding the piloting, navigation or the craft itself. Such information is presented on display screens arranged on the instrument panel in front of the crew. To select, modify or delete information, the pilot uses human/machine interfaces that are conventionally a computer “pointer” linked to a designator. This designator is generally of the computer “mouse” type. It is also possible to use touch screens to provide the same functions. Currently, the quantity of information is such that it is no longer possible to present a single set of information of a given type on a screen dedicated to this set. It is necessary to present several sets of information of different types on one and the same screen. For example, the air navigation screens used in aircraft cockpits present numerous information sources that are overlaid on one another. These include, notably:
the relief of the terrain generally presented with shading;
the planimetric information such as the roads, rivers, towns, etc.;
navigation information such as the beacons, air routes, the flight plan of the craft, etc.;
the air traffic information showing the aircraft located in the vicinity of the craft;
meteorological information.

Each of these information categories can be configured with a more or less dense level of information. This gives very wide variability in the overall configuring of the cartographic display. To allow for correct legibility of all this information, the solution most commonly used is to offer the user a fixed list of possible presentation configurations. The user can therefore choose between three or four display solutions. For example, it is possible to have:
the “visual flight” configuration which displays only the terrain and planimetry information,
the “weather” configuration which displays the weather and a simplified representation of the traffic information, etc.

One of the drawbacks with this type of presentation is that it is not possible to offer the user representation modes that have not been provided in the design. For example, it is not possible to have the weather information superimposed on the planimetry information, if such an arrangement was not initially provided by the system designer.

Another possible approach is to provide the user with a complete configuration of everything he wants to display. This approach offers two drawbacks:
this configuration is tedious and difficult to perform;
once the configuring is done, it is very difficult to ascertain its state. For example, given a display that does not show any roads, it is difficult to say whether the display of the roads has been deactivated or whether there is actually no road at this point.

### SUMMARY OF THE INVENTION

The invention proposes a principle for presenting and selecting these various display modes that is more ergonomic than those of the prior art.

More specifically, the subject of the invention is a display device for the management of systems comprising at least means of generating and displaying information concerning the system and a designator, characterized in that:

the information is classified by information themes, each information item is represented by one or more information symbols, a display priority level is associated with each information symbol of a given theme, arranged so that, when the information symbols of a given priority level are displayed, all the symbols of higher priority level are displayed, all the symbols of lower priority level are not displayed;

the display means comprise sets of information control symbols, the display of the control symbols being controlled by the designator, each set of control symbols being associated with a given information theme, the displayed control symbols corresponding to the display priority levels of the information symbols of said theme, the display of the control symbols leading to the display of the information symbols of the associated display priority levels.

Advantageously, each set of control symbols comprises a variable set of central symbols, the number of central symbols displayed corresponding to the display priority level of the theme controlled by said set of symbols.

Advantageously, each set comprises at least one first end representation that is constantly displayed and/or at least one second end representation that is constantly displayed.

Advantageously, the central symbols are identical rectangles. In this case, the first end symbol is substantially a first rectangle, the second end symbol is substantially a trapezoid, the set of the symbols representing a “pull knob”.

Advantageously, the central symbols have a substantially triangular shape, are all identical and all have a common peak.

Advantageously, the first end symbol comprises an icon or a term that are representative of the associated theme.

Advantageously, the various information control symbols are represented side by side.

Advantageously, the system is a flight management system of an aircraft, the information relates to the piloting or the navigation of said aircraft and the display means are the instrument panel displays.

### BRIEF DESCRIPTION OF THE DRAWINGS

The invention will be better understood, and other benefits will become apparent, from reading the following description given by way of nonlimiting illustration, and thanks to the appended drawings in which:

FIGS. 1, 2 and 3 represent, in the context of an aeronautical application, a display screen implementing the invention according to a first graphic representation.

FIG. 4 represents, in the context of an aeronautical application, a display screen implementing the invention according to a second graphic representation.

### MORE DETAILED DESCRIPTION

As an example, the description of the device according to the invention is given in the context of aeronautical applications. In this context, the system is a flight management system of an aircraft essentially comprising electronic computers, sensors, instrument panel displays and at least one designator. The information then concerns the piloting or navigation of the aircraft.

To implement the device according to the invention, the different information items are grouped together by theme. For example, the various themes are planimetry, meteorology, air traffic in the vicinity of the craft, etc.

For each of the themes concerned, a set of display configurations is defined, ranging from the least cluttered to the most cluttered. As an example, for air traffic, it is possible to have five configuration levels, which are:
“zero” level: no traffic information;
“minimum” level: only traffic presenting a risk to the aircraft is represented by a symbol only;
“normal” level: all traffic is represented by a single symbol;
“detailed” level: all the traffic is represented by a symbol, a heading and a speed;
“maximum” level: all the traffic is represented by a symbol, a heading, a speed, a name and other detailed information.

The same sorting can be applied for each theme. The user can select these different configurations by means of sets of control symbols, the aspect of which changes in proportion to the level of detail selected for the type of information represented, this aspect being able, for example, to be presented in the form of “pull knobs” or “pie charts”. A “pull knob” or a “pie chart” is permanently presented on the cartographic screen for each available theme.

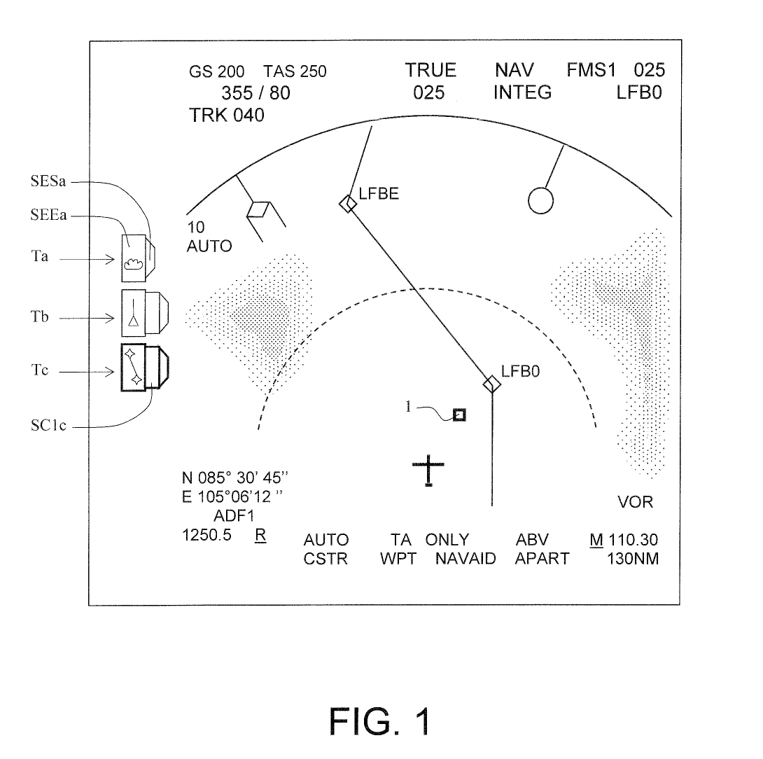

Three “pull knobs” denoted Ta, Tb and Tc are represented in FIGS. 1, 2 and 3. These figures represent, in a highly diagrammatic way, a display screen of “Navigation Display” type. This screen presents to the pilot all the information necessary for the navigation of the craft. It essentially consists of a plan view of the terrain being flown over including information concerning the craft and its environment.

In FIGS. 1, 2 and 3, the three pull knobs are arranged in a column on the left edge of the screen. They could, of course, be arranged on any other edge of the screen. In this case, it would be necessary to modify their arrangement.

Each pull knob comprises at least two symbols SEE and SES, called end symbols, and a variable set of central symbols SC arranged between the two end symbols, the number of central symbols displayed corresponding to the display level of the theme controlled by said set of symbols. In FIGS. 1, 2 and 3, the first end symbol SEE is substantially a first rectangle, the second end symbol SES is substantially a trapezoid and the central symbols SC are identical rectangles with dimensions slightly less than the first rectangle so as to give the illusion that the central symbol “come out” of the first rectangle SEE, by being pulled by the end SES. The first end symbol SEE can comprise an icon or a term that are representative of the associated theme. For example, the first end symbol SEEa of the “pull knob” Ta controlling the meteorological information can comprise an icon making it possible to associate it mentally with the type of information represented. The “pull knobs” can be of the same color or different colors, and can include shading or any other graphic device likely to improve their ergonomy or their representation.

The “pull knobs” are manipulated by means of a designator. The designator can be a mouse or a “trackball” or a “joystick” or any other designation means. For example, a pull knob can be manipulated by operating the roller wheel of a mouse. By rotating the roller wheel, a certain number of central symbols SC are made to appear or disappear, varying the display level of the “pull knob”.

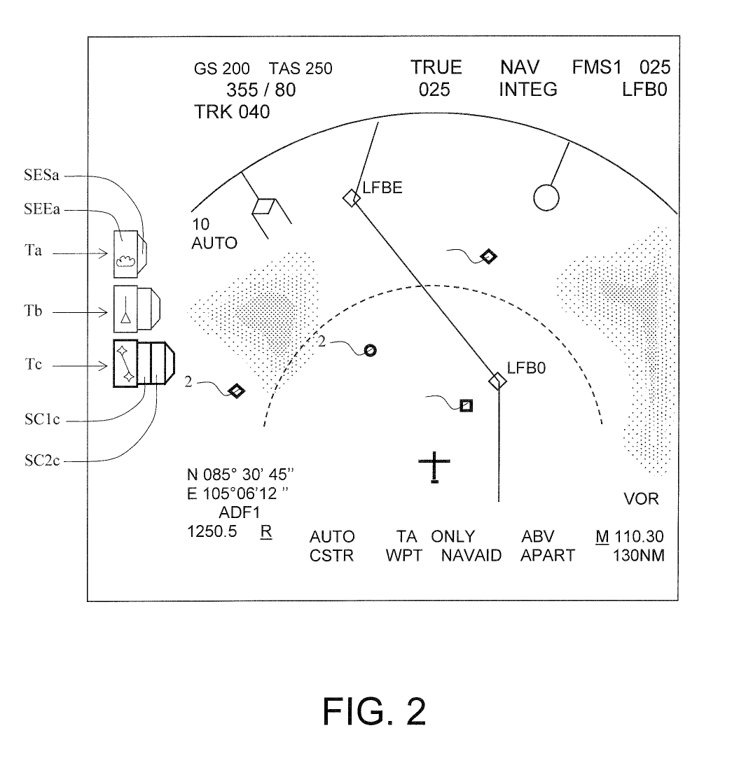

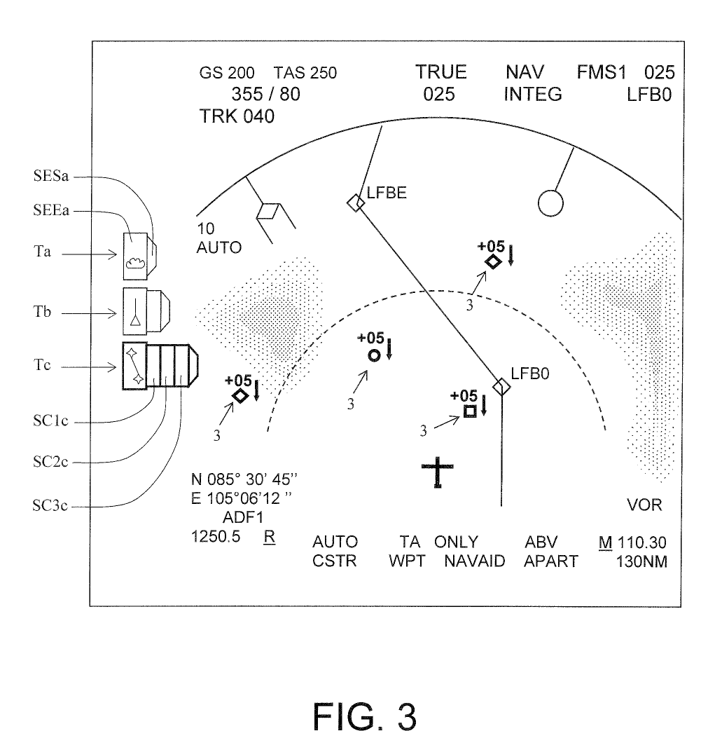

The “pull knobs” are more or less extended according to the desired configuration level for each of the themes. For example, in FIGS. 1, 2 and 3, the third “pull knob” Tc represents the state of the air traffic. The air traffic information is represented in bold lines in these different figures. In FIG. 1, this “pull knob” Tc includes just one central symbol SC1c, which corresponds to the “minimum” level of presentation of the traffic information. Only the square 1 which represents a craft likely to represent a danger to the aircraft is depicted. In FIG. 2, this “pull knob” Tc includes two central symbols SC1c and SC2c, which corresponds to the “normal” level of presentation of the traffic information. All the craft placed in the environment for the aircraft are depicted by a single symbol denoted 2. In FIG. 3, this “pull knob” includes three central symbols SC1c, SC2c and SC3c, which corresponds to the “detailed” level of presentation of the traffic information. All the craft placed in the environment for the aircraft are depicted by several symbols 3.

Since all the “pull knobs” are presented side by side, the pilot immediately knows the overall configuration retained for the display. He immediately sees which theme is favored. He can easily interact with the “pull knobs” to simplify or enrich an information type.

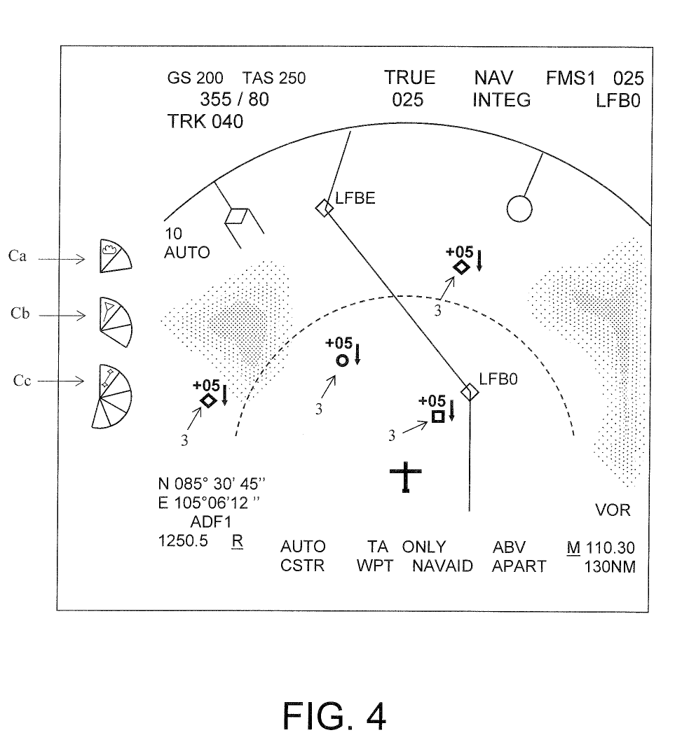

In FIG. 4, as a second example, the rectangular symbols of the control “pull knobs” have been replaced by symbols Ca, Cb and Cc with a circular segment shape, the set of the symbols displayed progressively filling “pie charts”. Three “pie charts” Ca, Cb and Cc are represented in FIG. 4. The method of controlling the circular segments is identical to that of the symbols of the “pull knobs”. Here again, the “pie charts” can be of the same color or different colors, and can include shading or any other graphic device likely to improver their ergonomy or their representation.

In a first variant, it is also possible to envisage the use of predefined configurations which automatically set all the pull knobs to a saved state. In a second variant, it is possible to add a function for saving the current state of the “pull knobs” or “pie charts”, and buttons leading directly to a predefined state for all the “pull knobs” or “pie charts”.

What is claimed is:

1. A display device for the management of systems comprising at least means of generating and displaying information concerning the system and a designator, wherein:
the information is classified by information themes, each information item is represented by one or more information symbols, a display priority level is associated with each information symbol of a given theme arranged so that, when the information symbols of a given priority level are displayed, all the symbols of higher priority level are displayed, all the symbols of lower priority level are not displayed;
the display means comprise sets of information control symbols, the display of the control symbols being controlled by the designator, each set of control symbols being associated with a given information theme, the displayed control symbols corresponding to the display priority levels of the information symbols of said theme, the display of the control symbols controlling the display of the information symbols of the associated display priority levels, each set of control symbols comprises a variable set of central symbols, the number of central symbols displayed corresponding to the display priority level of the theme controlled by said set of symbols.

2. The display device as claimed in claim 1, wherein each set comprises at least one first end representation that is constantly displayed.

3. The display device as claimed in claim 2, wherein each set comprises at least one second end representation that is constantly displayed.

4. The display device as claimed in claim 1, wherein the central symbols are identical rectangles.

5. The display device as claimed in claim 4, wherein the first end symbol is substantially a first rectangle, the second end symbol is substantially a trapezoid, the set of the symbols representing a “pull knob”.

6. The display device as claimed in claim 1, wherein the central symbols have a substantially triangular shape, are all identical and all have a common peak, the set of the symbols representing a “pie chart”.

7. The display device as claimed in claim 2, wherein the first end symbol comprises an icon or a term that are representative of the associated theme.

8. The display device as claimed in claim 1, wherein the various information control symbols are represented side by side.

9. The display device as claimed in claim 1, wherein the system is a flight management system of an aircraft, that the information relates to the piloting or the navigation of said aircraft and that the display means are the instrument panel displays.
